(19) United States
(12) Patent Application Publication
(10) Pub. No.: US 2025/0276634 A1
(43) Pub. Date: Sep. 4, 2025

(54) FLOOR-MOUNTED CART SECUREMENT SYSTEM

(71) Applicant: Ancra International LLC, Hebron, KY (US)

(72) Inventors: Joaquim Carlos DA ROSA, Independence, KY (US); Howard Thomas KNOX, Cold Spring, KY (US)

(21) Appl. No.: 19/061,422

(22) Filed: Feb. 24, 2025

Related U.S. Application Data
(60) Provisional application No. 63/559,559, filed on Feb. 29, 2024.

(51) Int. Cl. B60P 7/15; B60P 1/64

(52) U.S. Cl. CPC B60P 7/15; B60P 1/6427; B60P 1/649

(57) ABSTRACT

A floor-mounted securement system can be used to secure carts in a cargo compartment or container (e.g., in the front-to-back direction of a cargo container). The system can include various components, such as one or more logistics tracks positioned along the floor of the cargo compartment. In addition, the system can include a stopper that can releasably attach to the logistics track and that can be slid along the track to change positions of the stopper.

### CROSS-REFERENCE TO RELATED APPLICATIONS

This application claims the benefit of U.S. Provisional Application No. 63/559,559, filed Feb. 29, 2024 and entitled “FLOOR-MOUNTED CART-SECUREMENT SYSTEM.” The aforementioned application is hereby incorporated by reference in its entirety

### BACKGROUND

Carts are often used to transport goods within cargo compartments, such as cargo containers that can be transferred from ships to trailer trucks. The use of such carts may reduce the amount of time needed to move good into the container. Some cargo compartments include wall-mounted securement systems to secure carts in position and reduce the likelihood of shifting during transport.

### BRIEF DESCRIPTION OF THE FIGURES

Examples of a floor-mounted system for securing cars are described in detail below with reference to these figures.

FIG. 1 illustrates a perspective view of an example of a floor securement system in accordance with the present disclosure.

FIGS. 2A-B illustrate different views of a cargo compartment of a cargo container with carts and an example of a floor securement system in accordance with an aspect of the present disclosure.

FIG. 3 illustrates an example of a track in accordance with an aspect of the present disclosure.

FIG. 4 illustrates a side cross-sectional view from an end of the track of FIG. 3.

FIG. 5A illustrates a perspective view of a stopper assembly in accordance with an aspect of the present disclosure.

FIG. 5B is a partial cutaway view of the stopper assembly of FIG. 5A from a different perspective.

FIG. 6 is a perspective view of a stud of the stopper assembly of FIG. 5A.

FIG. 7 show a partially see-through view of the stopper assembly of FIG. 5A in engagement with the track of FIG. 3 in accordance with an aspect of the present disclosure.

FIGS. 8A-B show a cross-sectional view of the stopper assembly of FIG. 5A in different stages of engagement with the track of FIG. 3.

FIG. 9 illustrates another example of a stopper assembly in accordance with the present disclosure.

FIGS. 10A and 10B is are perspective views of an alternative example locking mechanism for a stopper assembly in accordance with the present disclosure.

FIGS. 11A and 11B are perspective views of an example stopper assembly with the alternative example locking mechanism of FIGS. 10A and 10B.

### DETAILED DESCRIPTION

The present disclosure describes a securement system that includes one or more components that can be removably attached to the floor of a cargo compartment so that the carts are secured into position. In some examples, the carts can be secured in a longitudinal direction (e.g., in the front-to-back direction of a cargo container) to reduce shifting while the cargo compartment is in motion. The system is designed to be able to accommodate different sized carts that may be in different positions within the cargo compartment from trip to trip. Components of the system (e.g., logistics tracks) that are fixed to the floor are designed to minimize the risk of tripping.

Carts are often used to transport goods within cargo compartments, such as trailer truck cargo compartments. The use of such carts may reduce the amount of time needed to bring goods into the cargo compartment. However, these carts need to be secured to prevent them from rolling, sliding, or tipping over when the cargo compartment is in motion (e.g., moved by ship, crane or truck). Securing the carts in place can itself be a time consuming exercise.

In conventional cargo compartment set-ups, straps (e.g., logistic straps) can to secure the carts. The straps are effective at securing the carts in place but can be quite inefficient in the loading and unloading process. For example, when not in used the straps may be stored in large bins, where they often become tangled and require time and effort to untangle them before use. Properly tightening and fastening the straps can also be time consuming.

Wall-mounted securement systems have been developed. However, they all require the use of some amount of space adjacent to the walls of the cargo compartment. This makes them incompatible with many carts, which, in order to maximize their cargo-carrying volume, are sized to extend from wall-to-wall within the cargo compartment.

While some conventional systems can include components that attach to the floor of the cargo compartment, they are associated with various drawbacks. For example, these conventional system are often not adjustable (e.g., fore-aft), and if they are adjustable, then they can require additional tools. This is problematic for cargo compartments where the positioning of one or more carts may vary from trip to trip, even if the carts have predetermined dimensions. For example, for trailers that transport food, the front section of the cargo compartment may be refrigerated, in which case an insulated divider may be used to isolate the refrigerated portion of the cargo compartment. The positioning of the insulated divider may vary depending on the size of the refrigerated section needed for a particular trip, which in turn affects the positioning of the carts that are lined up in the non-refrigerated section.

Thus there is a need for a cart securement system that secures carts in an adjustable fashion that is not mounted on the interior wall of the cargo compartment and is more efficient to use than conventional straps. The system must also be safe to use.

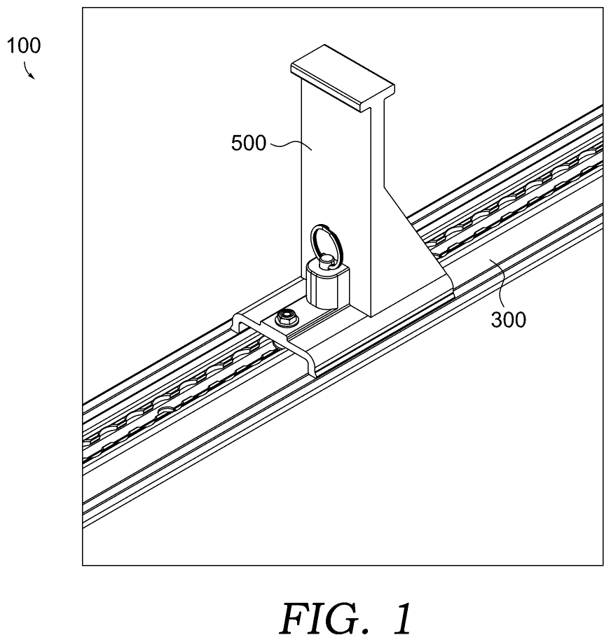

The floor securement system 100 is shown in FIG. 1, which includes track 300 and a stopper assembly 500, further described herein.

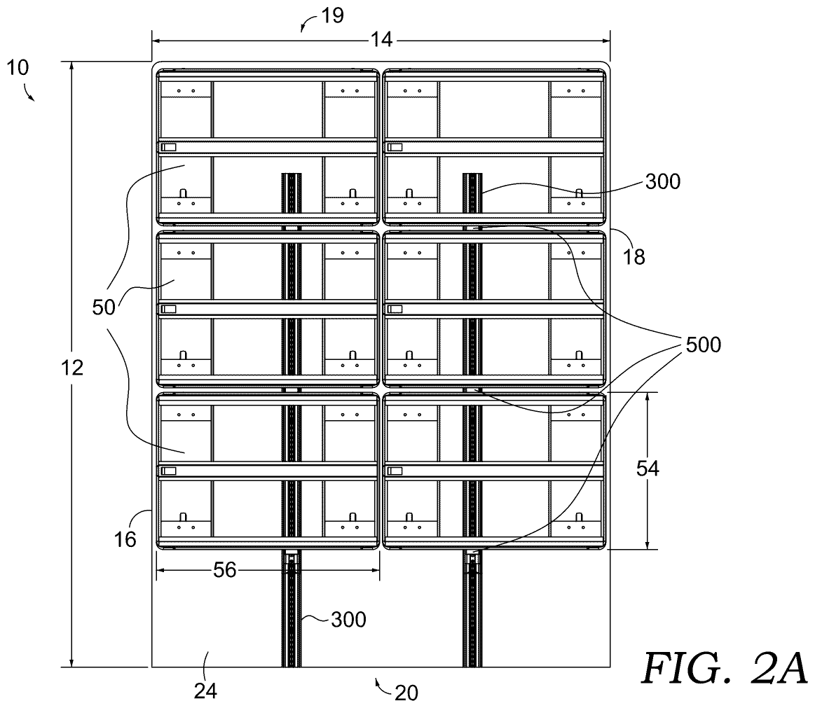

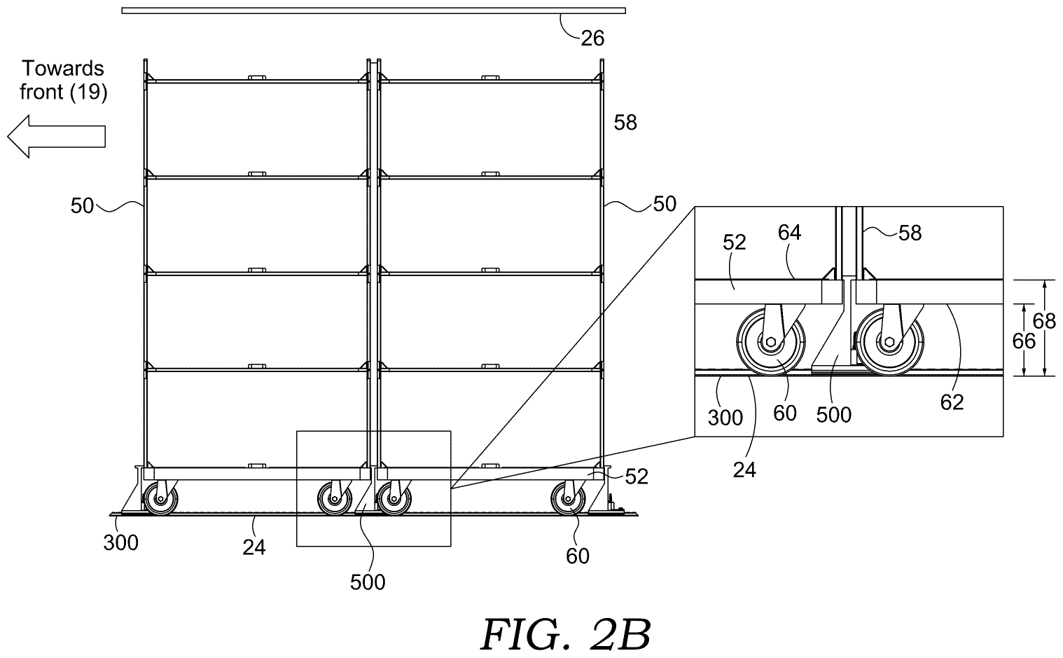

Turning now to FIG. 2A, a top down cutaway view of the cargo compartment 10, with a plurality of carts 50 shown fitting within the cargo compartment 10. Cargo compartment 10 may be the inside of a shipping container, a refrigerated truck trailer, or other cargo space known in the art. Cargo compartment 10 has an internal length 12 and an internal width 14. In examples, the left interior wall 16 and the right interior wall 18 are generally parallel with each other. Cargo compartment 10 also has a front end 19 and a back end 20, with the back end 20 being configured to open and close, e.g., fitted with doors. FIG. 2B illustrates a section of the cargo compartment 10 from the side, in which two carts 50 can be seen between the floor 24 and the ceiling 26.

Tracks 300, such as the one shown in FIG. 1 and FIGS. 3-4, may be positioned along the floor 24, running generally parallel to the left and right interior walls 16, 18 of the cargo compartment 10. In an example, each track 300 is a single piece that runs the length 12 of the cargo compartment 10. In other examples, multiple segments of track 300 can be laid end-to-end serially to run the entire length 12 of the cargo compartment 10, or only a part of the length of the cargo compartment 10. In the example of FIG. 2A, two tracks 300 are laid in parallel along a part of the length 12 of the cargo compartment 10, but other configurations are contemplated to be within the scope of this disclosure. In some examples, the track or tracks 300 can be oriented in any direction relative to the cargo compartment, including g side-to-side or laterally, diagonally, or fore-aft/longitudinally. The tracks 300 can also run along the entire length 12 of the cargo compartment 10.

As seen in FIGS. 2A-C, one or more carts 50 can be positioned within the cargo compartment 10. Each cart 50 depicted in FIGS. 2A-C has a bottom 52, which has a length 54 and a width 56. Cart 50 may also have a shelving structure 58 attached to the top surface of the cart 50, or another structure for helping to organize or secure goods on the cart 50. A plurality of wheels 60 are attached to the cart bottom 52, which may be mounted on rotatable casters. The bottom 52 has a lower surface 62 (which faces the floor 24 of the cargo compartment 10) and an upper surface 64, on which goods can be placed. There is a clearance height 66 between the cargo compartment floor 24 and lower surface 62 of the cart bottom 52, and a height 68 between the cargo compartment floor 24 and the upper surface 64. Cart 50 has a width 56 that is slightly less than the internal width 14 of the cargo compartment 10. In the example of FIGS. 2A-C, each cart 50 is approximately half the width 14 of the interior of cargo compartment, so that two carts 50 may be arranged in rows side-by-side within the cargo compartment 10.

In between the carts 50, stopper assemblies 500 are positioned on top of the track 300. Each stopper assembly 500 is releasably secured to the track 300, preventing the carts 50 from rolling in the front-to-back (e.g., forward or -backward) direction when they are locked into the track 300. In other examples, one stopper assembly 500 may be used to prevent multiple carts 50 from rolling in the front-to-back direction. For instance, a first cart can be positioned so that it abuts the front wall (or other secure fixture) of the cargo compartment 10, and a second cart can be positioned directly behind the first cart 50 so that they abut each other. A stopper assembly 500 is then secured to the track 300 so that it engages with the second cart on the opposite side of the first cart. The stopper assembly 500 thus prevents both the first cart and the second cart from moving in the backward direction, and the front wall of the cargo compartment prevents both carts from moving in the forward direction. It is readily appreciated that three or more carts can be similarly secured, or that a stopper assembly 500 in front of a first cart in a row of carts can serve the same stopping function in the forward direction as the front wall.

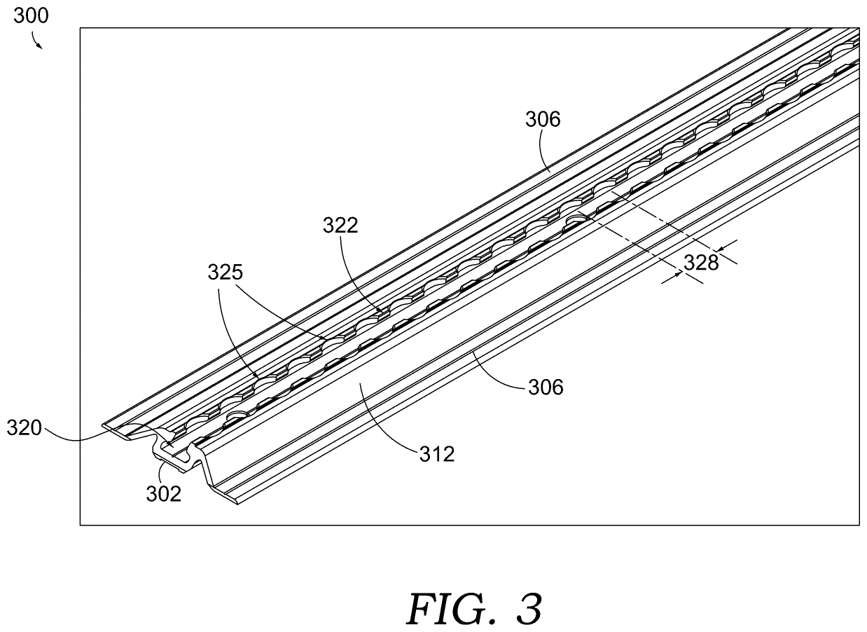

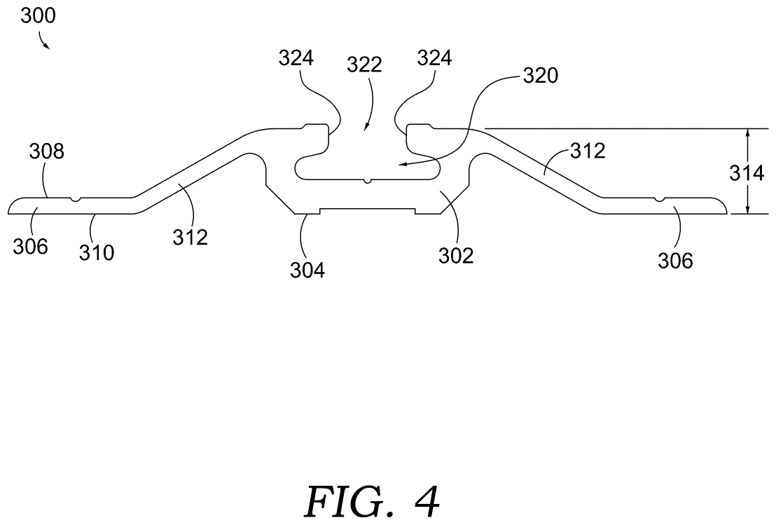

Turning back to FIGS. 3 and 4, each track 300 comprises a base 302 and an inverted T-shaped channel 320 that runs the length of the track 300, with the bottom of the “T” forming a slot 322 running the length of the track defined by edges 324 of the base 302 on either side of the slot 322. The base 302 has a bottom surface 304 that rests on the floor 24 of the cargo compartment 10, and two side portions 306, which each include a top surface 308, a bottom surface 310, and a connecting portion 312 that connects the side portions 306 to the base 302. In the example shown in FIG. 4, the connecting portions 312 are angled relative to the side portions 306 so as to provide a smoother profile of the track 300 when it is attached to the cargo compartment floor 24, minimizing their risk of becoming a tripping hazard. The track 300, upon being secured to the floor 24, has a height 314 above the floor 24, which is less than the clearance height 66 of the cart bottom 52 with the floor 24. The track 300 therefore does not impede the movement of the cart 50 in the front-back direction within the cargo compartment 10.

As shown in FIG. 3, circular cut-outs 325, each having a diameter 326 are spaced evenly along the slot 322, with the centers of adjacent circular cut-outs 325 spaced a distance 328 apart from each other.

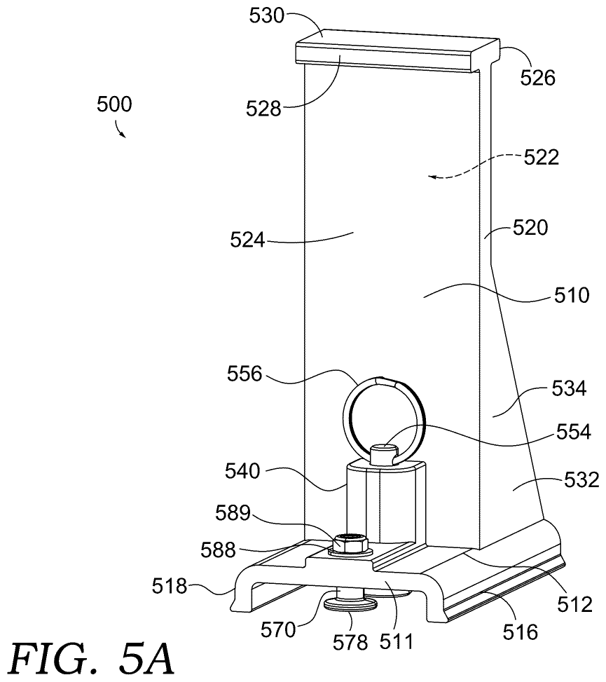

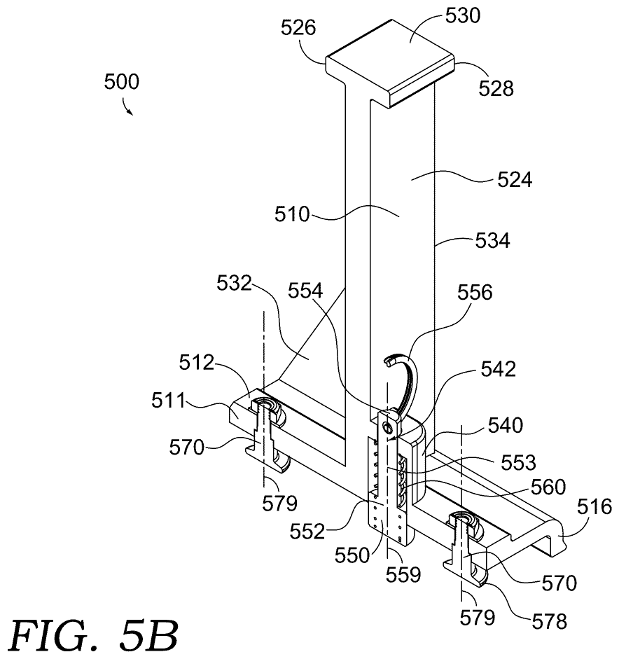

Turning now to FIGS. 5A-B, different views of the stopper assembly 500 are shown. Stopper assembly 500 comprises a stopper 510, a housing 540, and two studs 570. The stopper 510 comprises a base 511 and a top portion 520 extending from the top surface 512 of the base 511. In an example, the top portion 520 is a flange that projects from the top surface 512 of the base 511, with a front surface 522 and a back surface 524. Front projection 526 and back projection 528 extend from the top end 530 of top portion 520 in the front and back directions, respectively. As described in further detail below, the front projection 526 and back projection 528 can each engage with a cart to help prevent tipping of the cart during acceleration and deceleration of the cargo compartment 10. In an example, the top portion 520 includes side flanges 532 connecting its edges 534 to the top surface 512 of the base 511. Side flanges 532 (e.g., gussets) provide additional strength and stiffness to the top portion 520. In examples, the top portion 520 is formed of a solid piece of material, but one of skill in the art can readily contemplate other configurations and constructions that may reduce the amount of material used for the top portion while providing sufficient strength and stiffness.

The base 511 includes first and second legs 516, 518, which are configured to rest on top of either side portion 306 of track 300 (e.g., the terminal edges or “feet” of the legs 516, 518 rest atop, and can slide relative to, the side portions 306 of the track 300).

Near the center of the base 511 and adjacent the top portion 520 is a housing 540. Plunger 550 is disposed within the housing 540 along with spring 560. The plunger 550 has a plunger body 552 and a stem 553 with a free end 554 that extends out from opening 542 in the top of the housing 540. In examples, a ring 556 is inserted within a hole adjacent the free end 554 of the plunger stem 553 to retain the plunger 550 within the housing 540 when the stopper assembly is not in use. The plunger body 552 is cylindrical with a diameter slightly less than the diameter of the circular cut-outs 325 of the track 300. In examples, the plunger body 552 can include any shape that can mate into the openings in the track 300.

The spring 560 biases the plunger 550 into an extended downward position. A force pushing up on the plunger body 552 or pulling upwards on the ring 556 sufficient to overcome the force of the spring can shift the plunger 550 into an elevated position within the housing 540.

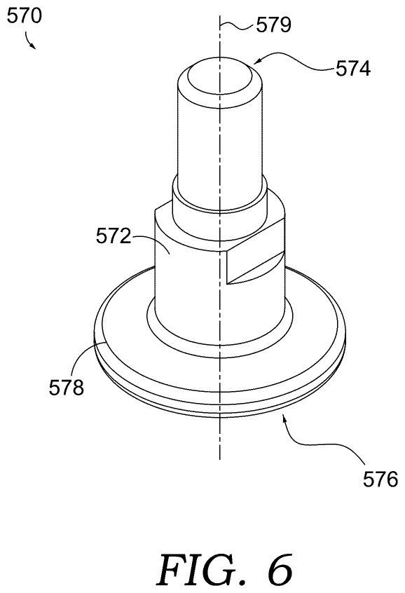

The stopper assembly further includes two studs 570 positioned on either side of the base 511. As shown in FIG. 6, each stud 570 comprises a stud body 572 having a top end 574 and a bottom end 576. A disc or head 578 extends out from the bottom end 576. The disc 578 has a cross dimension (e.g., diameter) that is smaller than the cross dimension (e.g., diameter) of the circular cut-outs 325 of the track but greater than the width of the slot 322. The stud body 572 is dimensioned to be less than the width of the slot 322. The top ends 574 of the studs 570 may be threaded, allowing them to be fastened to the base 511 using conventional fasteners such as washers 588 and nuts 589, or screwed directly into threaded holes in the base 511. In other examples, other fasteners or fastening systems can be used, or the studs 570 may also be adhered, bonded or welded to the base 511.

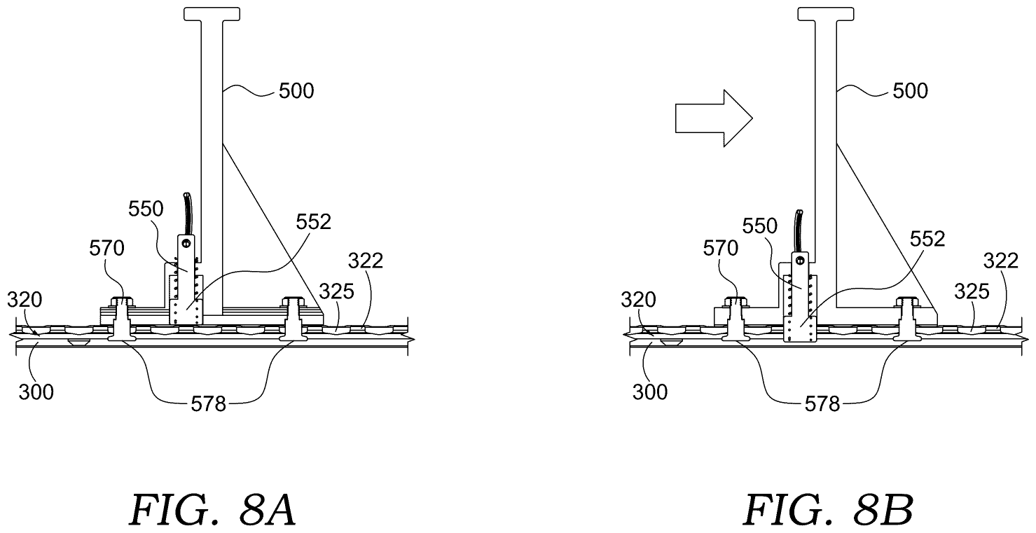

The stud axes 579 of the studs 570 are aligned with each other and the axis 559 of the plunger 550 to form a straight line when viewed from above. The two stud axes 579 are positioned so that they (and the centers of their respective discs 578) are spaced apart at a multiple of the distance D between two adjacent circular cut-outs 325 of the track 300 (i.e., a multiple of the distance 328 shown in FIG. 3). In the example shown in FIG. 1 (and as seen in FIGS. 8A and 8B), they are spaced five (5) Ds away from each other, with the plunger 550 positioned directly in between, so that the plunger's axis 559 is spaced 2.5 Ds apart from each stud axis 579.

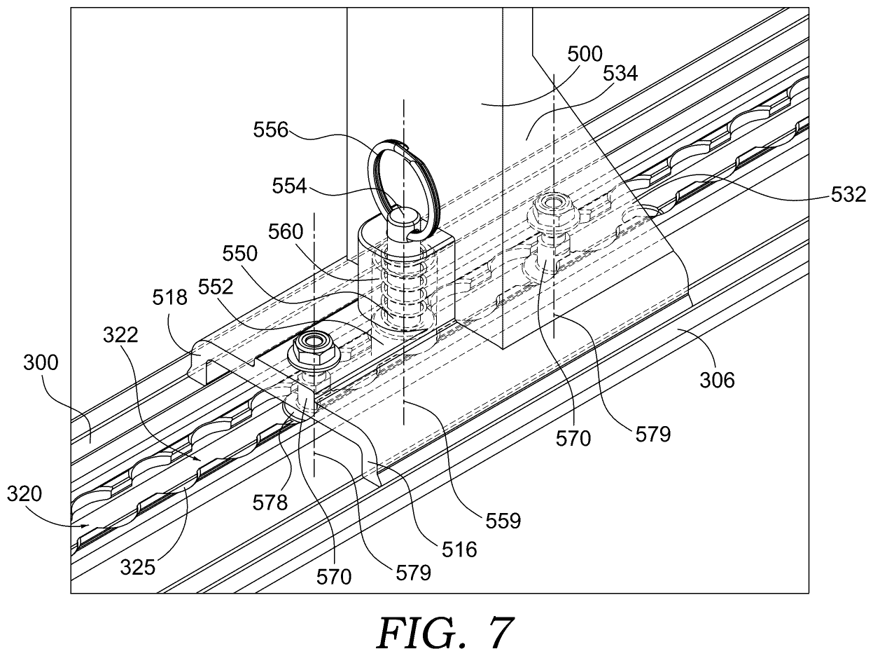

Turning now to FIGS. 7A-B and 8A-8B, a stopper assembly 500 such as the one shown in FIG. 5A can be placed on top of a track 300 such as the one shown in FIG. 3, so that the studs 570 are each aligned with one of the track's circular cutouts. As shown in FIG. 8A, the plunger 550 is not aligned with one of the cutouts in this position. As shown in FIG. 8B, pushing down on the stopper assembly with thus cause the studs 570 to be inserted into the circular cut-outs 325 so that the disks enter the channel 320, and the plunger, being pressed upwards by the track 300, is moved into its elevated position. In FIG. 8C, the stopper assembly is shifted along the track until the plunger aligns with one of the circular cut-outs 325 and, biased by the spring 560, is pushed into the cutout to lock the stopper assembly into place on the track 300 in the horizontal direction. The discs 578 of studs 570, now being out of alignment with the circular cut-outs 325, prevent the stopper assembly from disengaging with the track in the vertical direction. The legs 516, 518 of the base 511 prevent the stopper assembly 500 from rocking laterally.

To move the stopper assembly 500 to a different position (or to remove the stopper assembly 500 from the track), a user can pull up on the ring 556 until the plunger 550 is disengaged from the circular cut-out 325, and then the stopper assembly can be shifted along the length of the track to a desired position. If removal is desired, the stopper assembly 500 can be disengaged from the track 300, once the studs 570 are aligned with the circular cut-outs 325 of the track, at which point the stopper assembly 500 can be lifted up off the track.

Turning back to FIGS. 1A-C, it will be apparent to one of skill in the art how a plurality of stopper assemblies 500 can be used with a track 300 attached to the floor 24 of a cargo compartment 10 to secure multiple carts 50 in the front-back direction. Because the top end 530 of the stopper assembly (when it is attached to the track 300) projects over the top of the cart bottom 52, the front projection 526 and back projection 528 can extend over the upper surfaces 64 of the cart bottoms 52, which may provide additional protection against the carts 50 being rocked in the forward and backwards directions when the cargo compartment 10 is in motion. The size, configuration and orientation of the front projection 526 and the back projection 528 may be adapted to accommodate different sized carts. In an example, it is further contemplated that the front projection 526 and the back projection 528 may comprise adjustable parts that can be configured to engage with carts of different sizes, heights, etc. It can also be readily appreciated that multiple tracks 300 can be laid along and attached to the floor 24 so that multiple stopper assemblies 500 can be used to secure the same cart, which may be advantageous in situations where heavy loads are being transported.

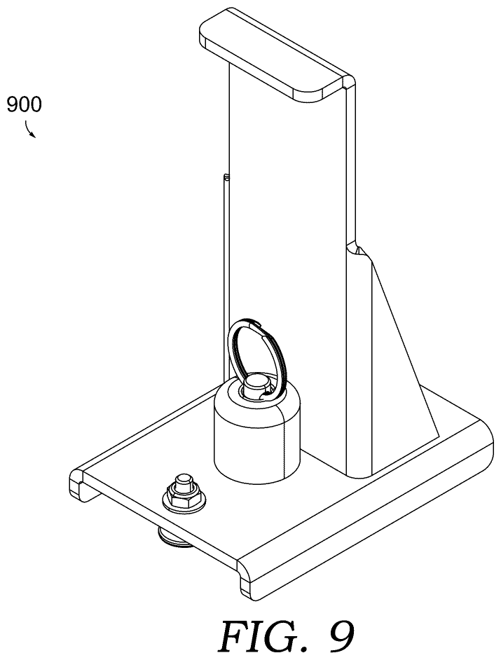

The components of the present disclosure can be formed with known methodologies, such as die-casting or forming out of sheet metal. In an example, the stopper assembly 500 is manufactured by die-casting aluminum. In other examples, such as the stopper assembly shown in FIG. 9, components of the stopper assembly 900 can be formed out of bending, stamping, and/or machining sheet metal, and then affixed to each other in a separate step, e.g., by welding or bonding.

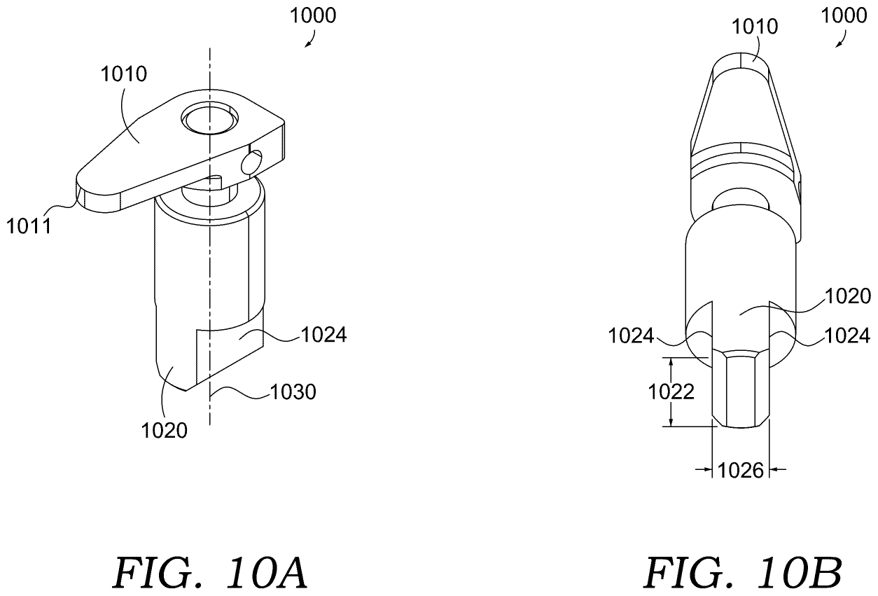

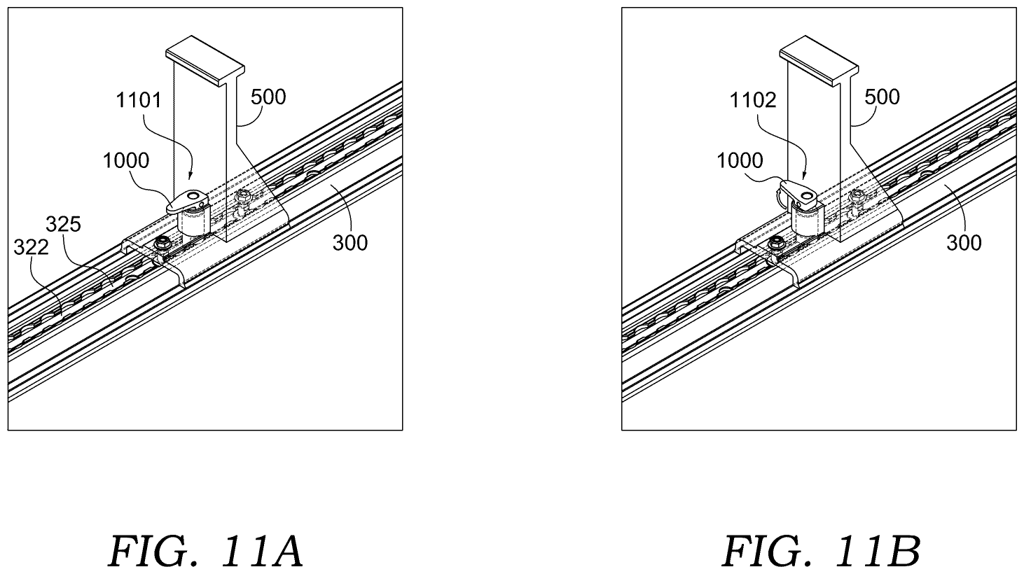

FIGS. 10A and 10B show an alternative to the plunger locking mechanism shown in the example of FIGS. 5A-B, with FIGS. 11A and 11B showing how a stopper assembly 500 with this alternative locking mechanism would engage with a track 300. Instead of a plunger 550, a rotating key 1000 may be rotatably housed within the housing 540 of the stopper assembly 500. The housing 540 may be configured to allow the key to rotate about its axis 1030 in a limited arc. At one end of the key is a handle 1010 that allows a user to rotate the key 1000 around an axis 1030 from a first unlocked position 1101 to a second locked position 1102. The opposite locking end 1020 of the key 1000 is configured so that in a first position it engages with a circular cut-out and in the second position is able to slide along the slot. In the example of FIGS. 10A and 10B, the locking end 1020 is in the shape of a cylinder having a diameter 1022 equal to or slightly less than the diameter of the circular cut-out 325, with two opposing horizontal cylindrical segments removed so that two parallel flat surfaces 1024 are formed, with the width 1026 between the flat surfaces 1024 being slightly less than or equal to the width of the slot 322 of the track 300. In an example, the handle 1010 is oriented so that its length is aligned with the flat surfaces 1024, allowing the user to determine the orientation of the flat surfaces 1024 without having to see them. Alternatively a visual marking can be applied to the handle to provide a similar benefit.

As can be seen in FIG. 11A, in the first unlocked position 1101, the flat surfaces 1024 of the locking end 1020 are aligned with the slot 322, allowing the stopper assembly 500 to slide along the track 300 in either longitudinal direction. When the axis of the key 1000 is aligned with the center of a circular cut-out 325, rotating the locking end 1020 into the second locked position 1102 (e.g., by applying a rotational force to the key via the handle 1010) engages the circular edges 1028 of the locking end 1020 with circular cut out 325 and prevents the stopper assembly 500 from sliding along the track 300.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar or equivalent to those described in this disclosure, and in conjunction with other present or future technologies. The examples herein are intended in all respects to be illustrative rather than restrictive. In this sense, alternative examples or implementations can become apparent to those of ordinary skill in the art to which the present subject matter pertains without departing from the scope hereof.

1. A system for securing a cart within a cargo compartment, comprising:
a track, the track comprising:
a track base with a bottom surface and a top surface;
a slot in the top surface having a first length and a first width; and
a channel in the track base having a second width that is greater than the first width;
a stopper assembly configured to be removably engaged the track, comprising:
a stopper base having a top and a bottom;
a top portion extending from the top of the stopper base;
a first stud extending from the bottom of the stopper base and configured to slidably engage the channel; and
a locking mechanism disposed at least partially within the stopper base and movable from a first position to a second position.

2. The system of claim 1, wherein the locking mechanism in the second position prevents the stopper assembly from sliding along the track.

3. The system of claim 2, wherein the locking mechanism comprises a plunger.

4. The system of claim 3, wherein the plunger is slidable from the first position to the second position.

5. The system of claim 4, wherein the stopper assembly further comprises a biasing mechanism that biases the plunger into the second position.

6. The system of claim 5, wherein the biasing mechanism comprises a spring.

7. The system of claim 2, wherein the locking mechanism comprises a rotatable key.

8. The system of claim 1, wherein the first stud further comprises a channel-engaging portion that is greater than the first width and less than the second width.

9. The system of claim 8, wherein the track further comprises a plurality of cut-outs evenly spaced along the slot, each of the plurality of cut-outs being configured to allow the channel-engaging portion of the first stud to pass through one of the plurality of cut-outs and into the channel.

10. The system of claim 9, wherein each of the plurality of cut-outs are circular, with a center of each of the plurality of cut-outs being a first distance away from each adjacent cut-out.

11. The system of claim 10, wherein the channel-engaging portion comprises a disc-shaped end.

12. The system of claim 11, wherein the locking mechanism comprises a cylindrical end having a diameter that is greater than the first width and less than or equal to the second width.

13. The system of claim 12, wherein a center of the cylindrical end of the locking mechanism and a center of the disc-shaped end are spaced apart by a second distance that is not equal to a whole multiple of the first distance.

14. The system of claim 13, wherein the stopper assembly further comprises a second stud extending from the stopper base, the second stud configured to slidably engage the channel and comprising a second disc-shaped end.

15. The system of claim 14, wherein the center of the disc-shaped end and a center of the second disc-shaped end are spaced apart by a third distance that is a whole multiple greater than 1 of the first distance.

16. The system of claim 15, wherein the third distance is an odd whole multiple of the first distance.

17. The system of claim 16, wherein the second distance is half of the third distance.

18. The system of claim 1, wherein the stopper base comprises at least one foot that is configured to rest upon the top surface of the track when the first stud is slidably engaged with the channel.

19. The system of claim 18, wherein the stopper base comprises a first foot and a second foot, the first foot resting upon the top surface of the track adjacent a first side of the slot and the second foot resting upon the top surface of the track adjacent a second side of the slot.

20. The system of claim 1, wherein the track is configured to be attachable to a floor of the cargo compartment.

21. The system of claim 3, wherein the top portion of the stopper assembly is configured to engage with the cart to prevent movement in at least one direction when the plunger is in the second position.

22. A stopper assembly configured to be removably engaged with a track comprising a track base with a bottom surface and a top surface, a slot in the top surface having a first length and a first width; and a channel in the track base having a second width that is greater than the first width; the stopper assembly comprising:
a stopper base having a top and a bottom;
a top portion extending from the top of the stopper base;
a first stud extending from the bottom of the stopper base and configured to slidably engage the channel; and
a locking mechanism disposed at least partially within the stopper base and movable from a first position to a second position.
